(19) United States
(12) Patent Application Publication
(10) Pub. No.: US 2003/0200079 A1
(43) Pub. Date: Oct. 23, 2003

(54) Cross-language information retrieval apparatus and method

(76) Inventor: Tetsuya Sakai, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/377,792

(22) Filed: Mar. 4, 2003

(30) Foreign Application Priority Data
Mar. 28, 2002 (JP) 2002-092925

(51) Int. Cl. G06F 17/28; G06F 17/20

(52) U.S. Cl. 704/8

(57) ABSTRACT

A machine translation portion machine-translates a retrieval request inputted by an input portion into the same language as that of a retrieval target document. Transliteration converts a phonogram in the retrieval request which has failed to be translated by the machine translation portion into a phonogram in the same language as that of the retrieval target document. A retrieval portion retrieves a document including the retrieval words from the document database based on the retrieval word generated by the machine translation portion and the retrieval word provided by the transliteration portion.

### CROSS-REFERENCE TO RELATED APPLICATIONS

This application is based upon and claims the benefit of priority from the prior Japanese Patent Application No. 2002-092925, filed Mar. 28, 2002, the entire contents of which are incorporated herein by reference.

### BACKGROUND OF THE INVENTION

1. Field of the Invention

The present invention relates to a cross-language information retrieval system, which realizes retrieval when a language of a retrieval request and a language of a retrieval target document are different from each other.

2. Description of the Related Art

In recent years, needs for cross-language information retrieval have been increased, for example, retrieval of an English document using Japanese, or retrieval from a database including French, German or Spanish documents using English.

Methods used for the above can be roughly divided into the following (i) to (iii).

(i) A retrieval request is translated into a language of a retrieval target.

(ii) A retrieval target is translated into a language of a retrieval request.

(iii) A retrieval request and a retrieval target are converted into intermediate expressions which do not depend on language.

In reality, (i), which results in a low translation cost, is in mainstream use.

As main resources for translating a retrieval request, there are (a) machine translation, (b) a bilingual word list, and (c) a parallel corpus. (c) consists of a large quantity of document data and its bilingual documents, and bilingual knowledge must be extracted therefrom by using a statistical technique or the like, but the completely automatically obtained bilingual knowledge does not necessarily have high reliability.

(b) is an approach which mechanically accesses a Japanese-English dictionary when, e.g., a retrieval request “ [symbol] ” is inputted, performs replacement for each word like “ [symbol] →information” or “ [symbol] →search” and executes retrieval based on “information, search”.

However, when an equivalent is obtained in accordance with each word in this manner, translation considering the context cannot be carried out. For example, in the above case, acquisition of a further appropriate retrieval condition “information, retrieval” may fail.

Although it is difficult to develop a machine translation system (a), an entire sentence is analyzed and translated by inputting a natural language sentence as a retrieval request, and hence it can be generally considered that a further correct translation can be obtained as compared with (b) or (c). The present invention relates to a cross-language information retrieval method using (i) retrieval request translation and (a) machine translation.

However, no matter how efficient the machine translation system is, words which are not registered in a machine translation dictionary, e.g., a new trendy word, a technical term or a company name cannot be successfully translated.

For example, a user whose mother tongue is English inputs a technical term “instanton” as a retrieval request, retrieval of a Japanese document can not be carried out if the machine translation fails to translate this word into a Japanese equivalent. On the contrary, if a Japanese user inputs “ [symbol] ”, retrieval of an English document cannot be performed if the machine translation fails to translate this word into an English equivalent.

As described above, as a well-known technique which is considered to be appropriate for translation of out-of-vocabulary words which cannot be successfully processed by machine translation, there is transliteration. For example, for Japanese and English, this technique previously prepares the basic correspondence relationship of phonograms, e.g., “ [symbol] ←→in”, “ [symbol] ←→n” and “ [symbol] ←→ton”, and realizes conversion of, e.g., “instanton → [symbol] ” or “ [symbol] →instanton” based on these combinations.

As a method realized, there is Jpn. Pat. Appln. KOKAI Publication No. 1997-69109 “document retrieval method and document retrieval apparatus”, for example. This publication discloses a method for realizing concrete transliteration which automatically performs transliteration of, e.g., “ [symbol] →instanton” when performing retrieval of a Japanese document based on a Japanese retrieval request, and assumes an application of use of both retrieval words “ [symbol] ” and “instanton” instead of retrieving by using only a katakana character string “ [symbol] ”, while allowing for the case where the word exists in English, in the Japanese document as it is.

However, in the environment of cross-language retrieval processed by the present invention, it is difficult to deal with translation of a retrieval request by using only transliteration. For example, when retrieving an English document by using Japanese, transliteration can be applied to only katakana words in the retrieval request.

### BRIEF SUMMARY OF THE INVENTION

It is, therefore, an object of the present invention to realize retrieval request translation having both the accuracy and the reliability in a cross-language information retrieval system which realizes retrieval when a language of a retrieval request is different from that of a retrieval target document, and thereby also realize cross-language retrieval with a high precision.

According to one embodiment of the present invention, there is provided a cross-language information retrieval apparatus which realizes document retrieval when a first language of a retrieval request is different from that of a retrieval target document, comprising: a document database which stores documents including each retrieval word, wherein each of the documents is stored in accordance with a plurality of retrieval words; an input device which inputs the retrieval request; a machine translation device which translates the retrieval request inputted from the input device into a second language associated with the retrieval target document and generates a first of the retrieval words in the language of the retrieval target document; a transliteration device which converts a phonogram in the retrieval request which has failed to be translated by the machine translation device into a phonogram in the second language associated with the retrieval target document and provides a result as a second of the retrieval words in the language of the retrieval target document; and a retrieval device which retrieves a document including the first of the retrieval words and the second of the retrieval words from the document database.

### BRIEF DESCRIPTION OF THE SEVERAL VIEWS OF THE DRAWING

FIG. 1 is a view showing a structure of one embodiment of a cross-language retrieval system according to the present invention;

FIG. 2 is a flowchart showing an example of processing by a translation portion in a first embodiment;

FIG. 3 is a flowchart showing an example of processing by a transliteration portion in the first embodiment;

FIGS. 4A and 4B are views showing an example of a data structure of a conversion rule used by the transliteration portion;

FIG. 5 is a flowchart showing an example of processing by a retrieval portion 14 in the first embodiment;

FIG. 6 is a view showing an example of a retrieval result obtained by the retrieval portion;

FIG. 7 shows a structure of a second embodiment of a cross-language retrieval system according to the present invention;

FIG. 8 is a flowchart showing an example of processing by a translation portion in the second embodiment;

FIG. 9 is a flowchart showing an example of processing by a transliteration portion in the second embodiment;

FIG. 10 is a view showing a display example of a screen when a machine translation result and a transliteration result are discriminated and compared, they are presented to a user and the user is caused to select a retrieval word in the first embodiment; and

FIG. 11 is a view showing a display example of the screen when a machine translation result and a transliteration result are discriminated and compared, they are presented to a user and the user is caused to select a retrieval word in the second embodiment.

### DETAILED DESCRIPTION OF THE INVENTION

The following describes embodiments of the present invention and does not restrict an apparatus and a method according to the present invention.

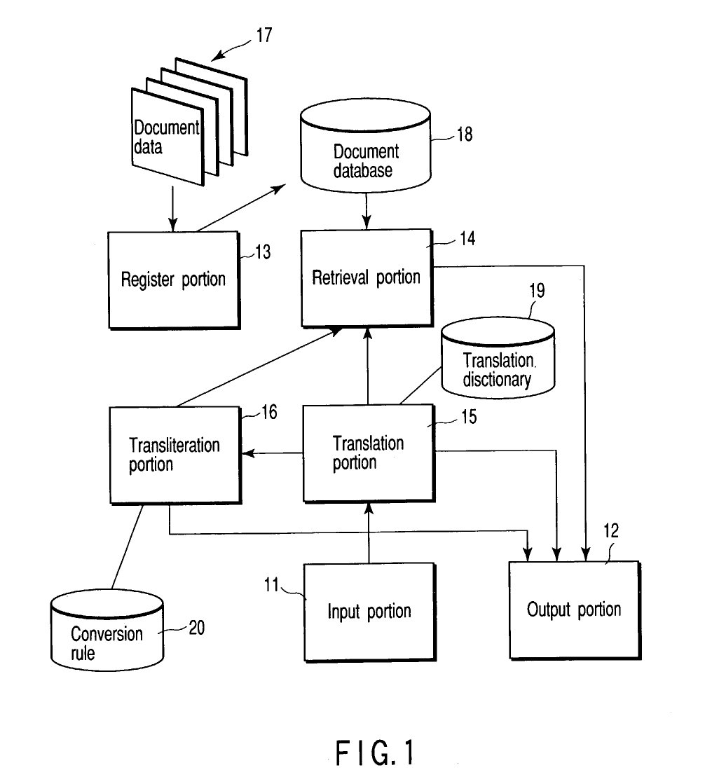

FIG. 1 shows a structure of an embodiment of a cross-language retrieval system according to the present invention.

This apparatus is schematically constituted by an input portion 11, an output portion 12, a register portion 13, a retrieval portion 14, a translation portion 15, and a transliteration portion 16.

Here, the input portion 11 and the output portion 12 correspond to a user interface of a computer, and correspond to an input device such as a keyboard or a mouse and an output device such as a computer display in terms of hardware. On the other hand, the register portion 13, the retrieval portion 14, the translation portion 15 and the transliteration portion 16 correspond to programs of the computer.

An outline of an entire processing flow of this apparatus will be first described in the following, and then processing flows of main modules will be explained.

(Entire Processing Flow)

Like a regular information retrieval system, the register portion 13 reads document data 17 as a retrieval target in advance, analyzes a document, and creates a document database (index) 18. The document data 17 includes a plurality of documents. As such documents, documents in any fields, such as science, medical science, entertainment, sports and others are included, and they may be newspaper or patent publications or the like. The register portion 13 detects a retrieval word (keyword) included in each document, and creates the document database 18 indicating which document each retrieval word is included in. In the document database 18, each document ID of a document including each retrieval word is registered as a table in accordance with a plurality of retrieval words. A plurality of documents may include the same retrieval word in some cases. In such a case, when a search is performed in the document database 18 by using one retrieval word, a plurality of documents are provided as a retrieval result.

A user inputs an arbitrary retrieval request to the input portion 11. This retrieval request is a natural language sentence, or one word phrase or word. Here, since cross-language retrieval is assumed, when the document data 17 is written in English for example, a retrieval request of a user is inputted in a language other than English, e.g., Japanese.

The inputted retrieval request is first transferred to the translation portion 15. The translation portion 15 tries machine translation of the retrieval request and generates a retrieval word. At this moment, only a part which has failed to be translated is transferred to the transliteration portion 16. Here, machine translation includes Japanese-to-English translation, English-to-Japanese translation, or translation from any other language to still another language. The transliteration portion 16 generates the retrieval word in the same language as the document data by transliteration. Finally, the retrieval portion 14 receives the retrieval words from the translation portion 15 and the transliteration portion 16, performs a search in the document database 18, and transfers a result to the output portion 12.

Detailed description will now be given as to processing of the translation portion 15, the transliteration portion 16 and the retrieval portion 14 which is the central feature of the present invention.

(Processing Flow of Translation Portion 15)

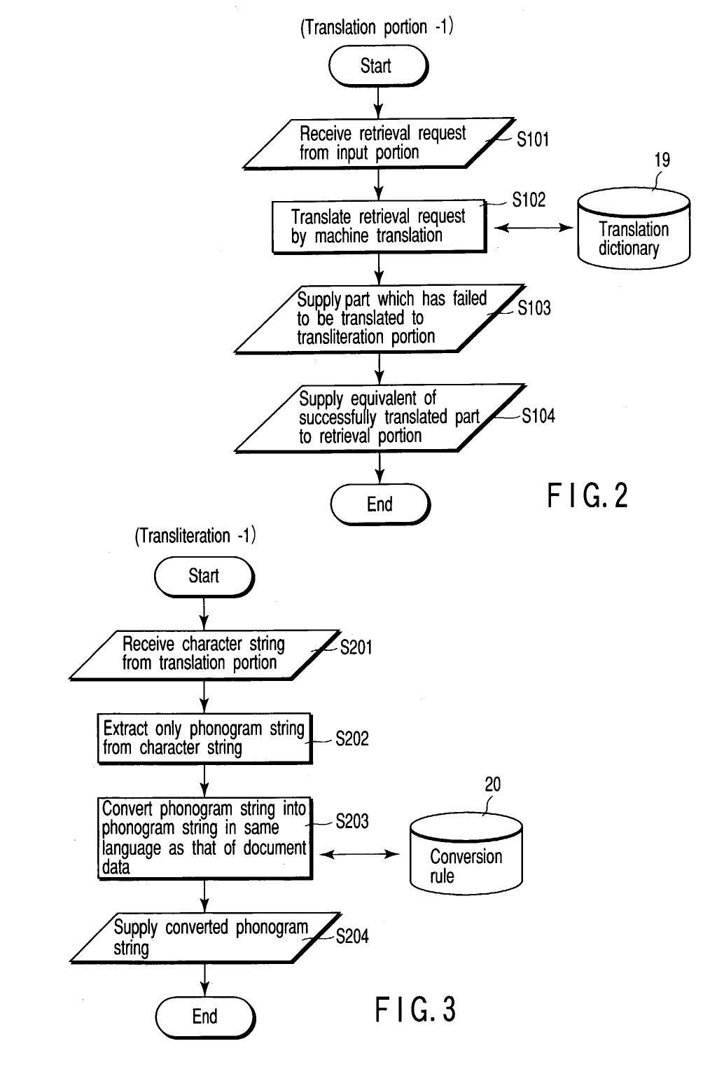

FIG. 2 shows an example of a flow of processing by the translation portion 15 in the first embodiment.

Upon receiving the retrieval request from the input portion 11, the translation portion 15 performs machine translation with respect to this retrieval request (S101, S102). For example, when the retrieval request is given in the form of a Japanese phrase “ [symbol] [symbol] ” and the document data 17 is written in English, the retrieval request is translated by Japanese-to-English machine translation.

Then, it is possible to obtain a data structure indicating the correspondence relationship of an original language and a translated language, e.g., “( [symbol] : [out-of-vocabulary word]), ( [symbol] : exist), ( [symbol] : evidence)” from machine translation. Incidentally, it is assumed that the word “ [symbol] ” has failed to be translated because it is not registered in a machine translation dictionary 19 in this example.

In the above case, the translation portion 15 transfers a character string “ [symbol] ” as a part which has failed to be translated to the transliteration portion 16 (S103). Then, the equivalents “existence” and “evidence” as successfully translated parts are transferred to the retrieval portion 14 as retrieval words (S104).

(Processing Flow of Transliteration Portion 16)

FIG. 3 shows an example of a flow of processing by the transliteration portion 16 in the first embodiment.

Upon receiving a character string from the translation portion 15, the transliteration portion 16 extracts only a phonogram string from this character string (S201, S202). In the example provided in the description of the translation portion 15, the character string “ [symbol] ” is transferred to the transliteration portion 16, but this is a phonogram string including no Chinese characters or the like as a whole, and hence this becomes a target of transliteration as it is. In the case of Japanese-to-English conversion, the transliteration portion 16 extracts katakana as a conversion target from the inputted character string.

In this case, the transliteration portion 16 converts the phonogram string “ [symbol] ” into the phonogram string in the same language as the document data 17 by using a later-described conversion rule 20 or the like (S203). For example, when the document data 17 is written in English, “ [symbol] ” is converted into “instanton” or the like. Finally, the transliteration portion 16 supplies this conversion result to the retrieval portion 14 (S204).

In the present invention, the transliteration technique is nor restricted, and it is possible to adopt such a technique as disclosed in Jpn. Pat. Appln. KOKAI Publication No. 1997-69109 mentioned above, for example. Here, an example of the transliteration technique will be described, but this itself is not the central feature of the present invention.

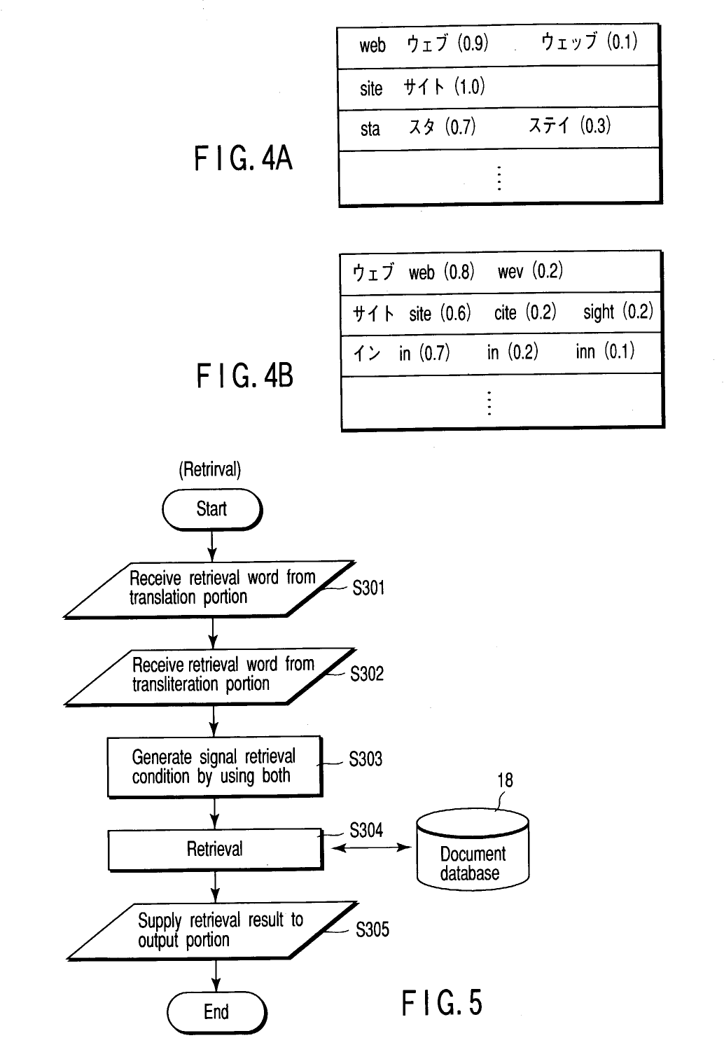

FIGS. 4A and 4B shows examples of a data structure of a conversion rule 20 used by the transliteration portion 16.

FIG. 4A shows an example of the rule for converting an English character string into a Japanese katakana character string, and (b) shows an example of the rule for converting the Japanese katakana character string into the English character string.

For example, a first entry in FIG. 4A indicates information that a character string “web” is converted into “ [symbol] ” with the probability of 0.9 and into “ [symbol] ” with the probability of 0.1.

Further, a third entry indicates information that a character string “sta” is converted into “ [symbol] ” with the probability of 0.7 and into “ [symbol] ” with the probability of 0.3. (This is because “sta” in “stack” or “statistic” is pronounced as “ [symbol] ”, but “sta” in “station”, or the like, is pronounced as “ [symbol] ”, for example). On the contrary, a second entry in FIG. 4B indicates information that a character string “ [symbol] ” is converted into “site” with the probability of 0.6, into “cite” with the probability of 0.2, and into “sight” with the probability of 0.2.

Such a rule must be prepared in advance. For example, in cases where the conversion rule as shown in FIG. 4A is used, when a character string “website” is supplied, the transliteration portion 16 first decomposes it into “web” and “site”, and then collates with the conversion rule. Consequently, conversion results “ [symbol] ” and “ [symbol] ” can be obtained.

Furthermore, based on the probabilities of “ [symbol] ”, “ [symbol] ” and “ [symbol] ” given in the conversion rule, by calculating the occurrence probability of each conversion result (probability that the conversion result is actually used) as, e.g., 0.9*1.0=0.9, 0.1*1.0=0.1, the priority levels can be readily provided to a plurality of conversion results. Moreover, one or several conversion results may be usually outputted in the order of probability.

Likewise, if such a conversion rule as shown in FIG. 4B is used, when a character string “ [symbol] ” is supplied, candidates such as “instanton”, “imstanton” and “innstanton” can be obtained with the priority levels based on the third entry and other entries in FIG. 4B.

(Processing Flow of Retrieval Portion 14)

FIG. 5 shows an example of a flow of processing by the retrieval portion 14 in the first embodiment.

The retrieval portion 14 receives retrieval words from the translation portion 15 and the transliteration portion 16 (S301, S302). In the example given in the description of the translation portion 15, “exist” and “evidence” are obtained from the translation portion 15 and “instanton (“imstanton”, “innstanton”) is obtained from the transliteration portion 16. Then, these words are regarded as retrieval words, the retrieval condition is generated, a search is performed, and retrieval results are supplied to the output portion 12 (S303 to S305).

As a modification, retrieval using the retrieval words given from the translation portion 15 and retrieval using the retrieval word obtained from the transliteration portion 16 may be separately carried out, and the obtained two retrieval results may be combined, thereby acquiring one retrieval result in the end. Specifically, for example, it can be considered that individual document scores are obtained from a sum or an average of the document scores in the two retrieval results.

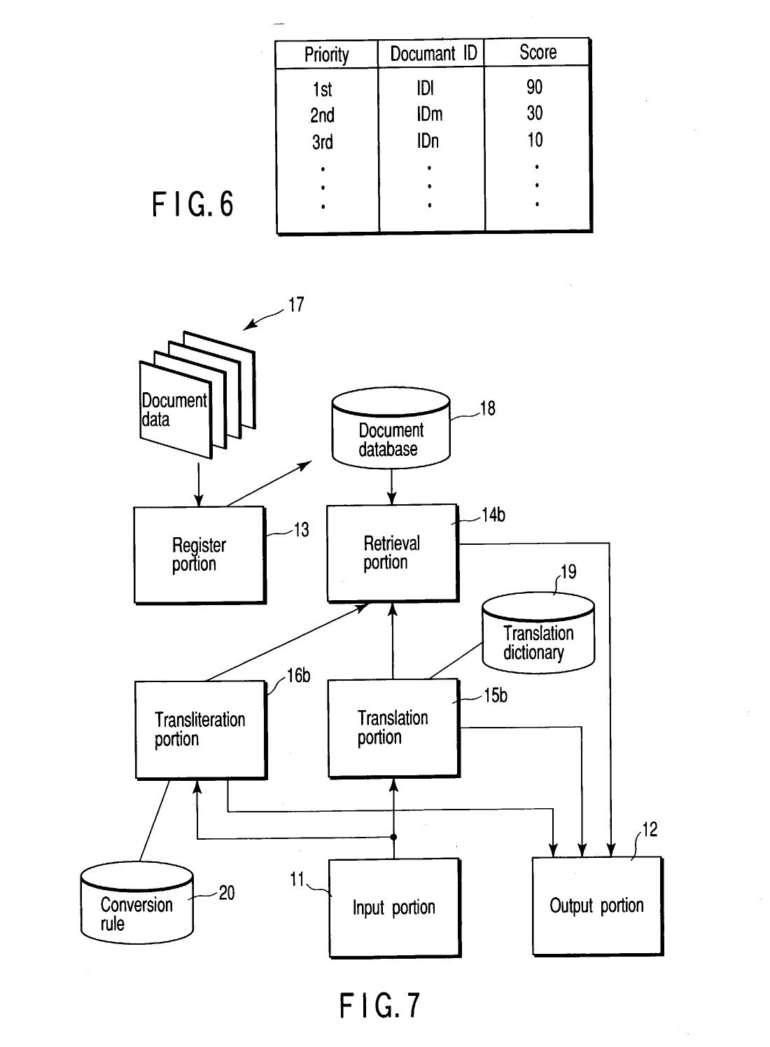

FIG. 6 shows an example of retrieval results.

In this example, the retrieval portion 14 first retrieves a document including “exist” from the document database 18. When there are hits (when a document including “exist” exists), a document ID of that document and a point value obtained by multiplying the number hits in the document, in the case of a plurality of hits with respect to the same document by, e.g., 10 points, is recorded. In regard to “evidence”, “instanton”, “imstanton” and “innstanton”, the document ID of the hit document and the point value of that document are likewise recorded. Then, the retrieval portion 14a records a value obtained by adding the point values obtained by the respective hit documents as a score. Finally, the retrieval portion 14 determines the priority of the documents in accordance with the scores, arranges the document IDs (or document names) of the hit documents in accordance with the scores, and supplies the result to the output portion 12.

With the above-described processing, since transliteration functions as a backup mechanism when machine translation has failed to translate the out-of-vocabulary word, it is possible to realize retrieval request translation with a high precision and cross-language retrieval with a high precision.

A second embodiment according to the present invention will now be described. FIG. 7 shows a cross-language retrieval system according to this embodiment.

The structure of the cross-language retrieval system in this embodiment is different from the first embodiment in that the retrieval request inputted by a user is simultaneously supplied to both the translation portion 15 and the transliteration portion 16 from the input portion 11. Description will be given as to the differences.

(Processing Flow of Translation Portion 15)

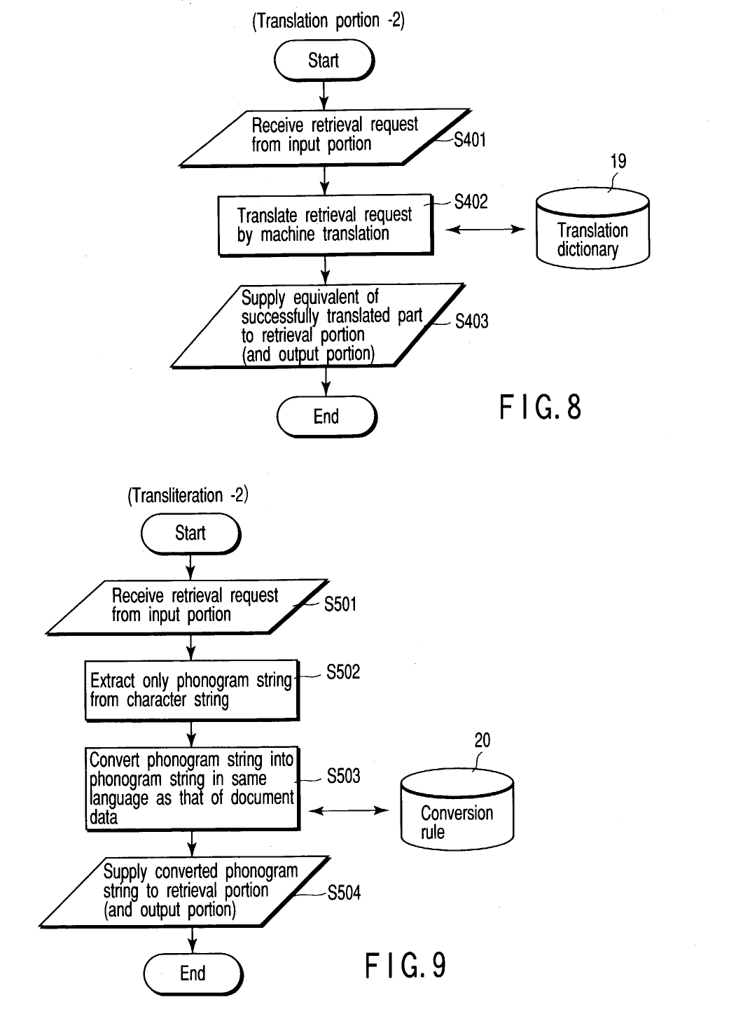

FIG. 8 shows an example of a flow of processing by a translation portion 15b in this embodiment.

The translation portion 15b receives the retrieval request from the input portion 11, and translates it by machine translation (S401, S402). Then, it supplies an equivalent of a successfully translated part to the retrieval portion 14b (S403). As will be described later in detail, when equivalent information is presented to a user, this is also supplied to the output portion 12.

For example, if an English phrase “Risk factors of heart diseases” is given as a retrieval request and a search for a Japanese document is carried out, it is assumed that a data structure “(risk factor: [symbol] ), (heart disease: [symbol] )” is internally obtained by machine translation. At this moment, the translation portion 15b supplies “ [symbol] ” and “ [symbol] ” to the retrieval portion 14b as retrieval words.

(Processing Flow of Transliteration Portion 16)

FIG. 9 shows an example of a flow of processing by the transliteration portion 16b in the second embodiment.

The transliteration portion 16b receives the retrieval request from the input portion 11 and extracts only a phonogram string from this retrieval request (S501, S502). In the example of “Risk factors of heart diseases” mentioned above, since the entire input is an English phrase, all the words are phonogram strings. Thus, the conversion rule described in connection with the first embodiment is used to the respective words such as “risk”, “factor”, “heart” and “disease”, and transliteration is carried out (S503). Note that a preposition such as “of”, an article, a conjunction and others may be deleted by collation with a list called “stop word list”. Moreover, it is determined that “s” added at the end of each word is mechanically eliminated in this example.

It is assumed that, for example, the correct conversion results “ [symbol] ”, “ [symbol] ”, and “ [symbol] ” were obtained with respect to “risk”, “factor” and “heart” by transliteration but a wrong conversion result “ [symbol] ” was obtained with respect to “disease”. (For example, it can be considered that this result is obtained by the conversion rules of “di: [symbol] ”, “sea: [symbol] ” and “se: [symbol] ”.) There is no guarantee that a correct conversion result will be obtained by transliteration in this manner, but the transliteration portion 16b supplies all the obtained conversion results (“ [symbol] ”, “ [symbol] ”, “ [symbol] ”, “ [symbol] ”) to the retrieval portion 14b as retrieval words (S504).

Although a flow of processing by the retrieval portion 14b is the same as that in the first embodiment, “ [symbol] ” and “ [symbol] ” are obtained from the translation portion 15b and “ [symbol] ”, “ [symbol] ”, “ [symbol] ” and “ [symbol] ” can be obtained from the transliteration portion 16b, and hence the retrieval portion 14b performs a search by using all of these words.

Here, it is assumed that there is a Japanese document which matches the English retrieval request “Risk factors of heart diseases” in the document database 18, an expression “ [symbol] [symbol] ” appears in that document but an expression “ [symbol] ” does not appear.

In this case, an internal data structure “(risk factor: [symbol] ), (heart disease: [symbol] )” is obtained from the translation portion 15b by using the method according to the first embodiment, and the out-of-vocabulary word is not detected. Therefore, the transliteration portion 16b is not operated.

That is, a search is performed by using only “ [symbol] ” and “ [symbol] ”. Thus, there is the possibility that a document which aboundingly includes “ [symbol] ” or “ [symbol] ” may appear at the top of retrieval results instead of the adequate document including the expression “ [symbol] [symbol] [symbol] ”.

On the other hand, since transliteration is carried out irrespective of presence/absence of a failure of machine translation in this embodiment, an appropriate document will appear at the top of the retrieval results.

It is to be noted that retrieval is carried out based on an inadequate conversion result such as “ [symbol] ” in the above example but such a word can not be a hit with the actual document in many cases. Therefore, it can be considered that the possibility that this adversely affects retrieval accuracy is low.

(Generation of Retrieval Condition Based on Priority)

In addition, in the first and second embodiments, the retrieval portion 14 may judge the priority of the machine translation result and the transliteration result and reflect this priority to the retrieval condition. For example, if the occurrence probability of each conversion result described in connection with the first embodiment is not more than a fixed value, the weight of the retrieval word after this conversion result may be lowered.

Specifically, if the inputted retrieval request is written in English while the document data is written in Japanese and there is such a conversion rule as shown in FIG. 4A, the occurrence probability when a character string “website” is converted into a character string “ [symbol] ” can be obtained as 0.9*1.0=0.9. Therefore, the reliability of the conversion result “ [symbol] ” is considered to be high. In this case, the retrieval word weight of the conversion result is equivalent to the retrieval word weight of the machine translation result.

On the contrary, if the inputted retrieval request is written in Japanese while the document data is written in English and there is such as conversion rule as shown in FIG. 4B, the occurrence probability when the character string “ [symbol] ” is converted into “website” is obtained as 0.8*0.6=0.48. In such a case, the retrieval word weight of “website” obtained by transliteration is lowered composed to the retrieval word weight obtained by machine translation. In general, since the ambiguity is high when performing inverse conversion from katakana into English rather when converting English into katakana, the reliability in the latter case tends to be lower.

Additionally, in the second embodiment, when both the machine translation result and the transliteration result are obtained with respect to the same word, adoption of one of these results as a retrieval word in accordance with the occurrence probability of the transliteration result can be also considered.

(Presentation to User/Selection by User)

Further, in the first and second embodiments, a result of machine translation and a result of transliteration may be discriminated and compared to be presented to a user, and the user can select accordingly.

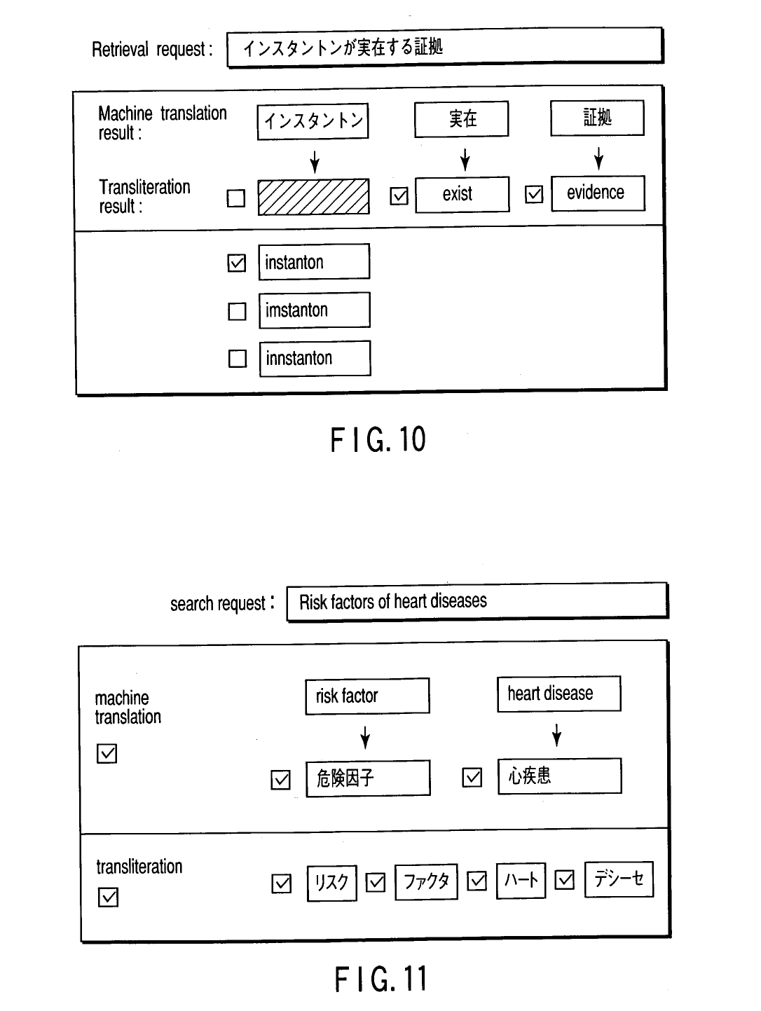

FIG. 10 shows a display example of a screen when a machine translation result and a transliteration result are discriminated and compared to be presented to a user and the user is caused to select either result as a retrieval word.

In this example, it is assumed that the Japanese retrieval request “ [symbol] [symbol] ” is inputted by a user and the English document is retrieved.

In a panel “machine translation result”, “ [symbol] ” and “ [symbol] ” have been respectively translated into retrieval words “exist” and “evidence”, but oblique lines indicate that translation of “ [symbol] ” has failed. Here, an equivalent such as “proof” as a retrieval word corresponding to “ [symbol] ” may be displayed as a retrieval word with a low priority. In a panel “transliteration result”, a plurality of transliteration results corresponding to “ [symbol] ” are displayed in the order of priority level (that is, the order of occurrence probability).

The user can readily determine which retrieval word is used by operating a check box given to each retrieval word candidate. In the state of FIG. 10, a search for the English document is performed by using three retrieval words “instanton” as the transliteration result and “exist” and “evidence” as the machine translation results.

FIG. 11 shows a display example of a screen when the machine translation result and the transliteration result are discriminated and compared to be presented to the user and the user is requested to select either result as the retrieval word.

FIG. 10 shows an example of performing a search for the English document based on the Japanese retrieval result, whereas FIG. 11 shows an example of performing a search for the Japanese document based on the English retrieval request, and it is assumed that the above-described “Risk factors of heart diseases” is inputted as the retrieval request by the user.

In the second embodiment, since the translation portion 15b and the transliteration portion 16b operate independently, the panel “machine translation” indicates that “risk factor” has been translated into “ [symbol] ” and “heart disease” has been rendered into “ [symbol] ” and, on the other hand, the panel “transliteration” indicates that character strings “ [symbol] ”, “ [symbol] ”, “ [symbol] ” and “ [symbol] ” have been obtained by transliteration.

Like FIG. 10, the user can select the retrieval word by operating the check box of each retrieval word candidate. Furthermore, the user may select a search using only the machine translation result, a search using only the transliteration result or a search using both by operating the check boxes immediately below words “machine translation” and “transliteration”.

When the machine translation result and the transliteration result are discriminated and compared to be presented to the user and final selection of a retrieval word is entrusted to the user, the user can learn to differentiate where machine translation is useful and where transliteration is useful, and it can be considered that cross-language retrieval which brings out advantages of the accuracy of machine translation and the reliability of transliteration with respect to an out-of-vocabulary word can readily achieve success.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A cross-language information retrieval apparatus which realizes document retrieval when a first language of a retrieval request is different from that of a retrieval target document, comprising:
a document database which stores documents including each retrieval word, wherein each of the, documents is stored in accordance with a plurality of retrieval words;
an input device which inputs the retrieval request;
a machine translation device which translates the retrieval request inputted from the input device into a second language associated with the retrieval target document and generates a first of the retrieval words in the language of the retrieval target document;
a transliteration device which converts a phonogram in the retrieval request which has failed to be translated by the machine translation device into a phonogram in the second language associated with the retrieval target document and provides a result as a second of the retrieval words in the language of the retrieval target document; and
a retrieval device which retrieves a document including the first of the retrieval words and the second of the retrieval words from the document database.

2. The apparatus according to claim 1, wherein the retrieval device comprises a priority judgment device which automatically judges priority of the first of the retrieval words generated by the machine translation device and the second of the retrieval words provided by the transliteration device and reflects the priority when generating a retrieval condition in the second language associated with the retrieval target document.

3. The apparatus according to claim 1, further comprising a display device which displays the first of the retrieval words generated by the machine translation device and the second of the retrieval words provided by the transliteration device.

4. The apparatus according to claim 3, wherein the display device comprises a selection device used to select any one of the retrieval words displayed, in order to perform retrieval by the retrieval device.

5. A cross-language information retrieval apparatus which realizes document retrieval when a first language of a retrieval request is different from that of a retrieval target document, comprising:
a document database which stores documents including each retrieval word, wherein each of the documents is stored in accordance with a plurality of retrieval words;
an input device which inputs the retrieval request;
a machine translation device which translates the retrieval request inputted from the input device into a second language associated with the retrieval target document and generates a first of the retrieval words in the language of the retrieval target document;
a transliteration device which converts the retrieval request inputted by the input device into a phonogram in the second language associated with the retrieval target document and provides a result as a second of the retrieval words in the language of the retrieval target document; and
a retrieval device which retrieves a document including the first of the retrieval words and the second of the retrieval words.

6. The apparatus according to claim 5, wherein the retrieval device comprises a priority judgment device which judges priority of the first of the retrieval words generated by the machine translation device and the second of the retrieval words provided by the transliteration device and reflects the priority when generating a retrieval condition in the second language associated with the retrieval target document.

7. The apparatus according to claim 5, further comprising a display device which displays the first of the retrieval words generated by the machine translation device and the second of the retrieval words provided by the transliteration device.

8. The apparatus according to claim 7, wherein the display device comprises a selection device used to select any one of the retrieval words displayed, in order to perform retrieval by the retrieval device.

9. A document retrieval method in a cross-language information retrieval apparatus which realizes document retrieval when a first language of a retrieval request is different from that of a retrieval target document, comprising:
detecting retrieval words included in a plurality of documents and registering information indicating which document includes each retrieval word as a document database;
inputting a retrieval request;
translating the inputted retrieval request into a second language associated with a retrieval target document and generating a first of the retrieval words in the language of the retrieval target document;
converting a phonogram in the retrieval request which has failed to be translated by machine translation into a phonogram in the second language associated with the retrieval target document, and providing a result as a second of the retrieval words in the language of the retrieval target document; and
retrieving a document including the first of the retrieval words and the second of the retrieval words.

10. The method according to claim 9, further comprising displaying the first of the retrieval words generated by machine translation and the second of the retrieval words provided by transliteration.

11. The method according to claim 10, further comprising causing a user to select any of the displayed retrieval words in order to perform retrieval.

12. A document retrieval program used to execute document retrieval in a cross-language information retrieval apparatus which realizes document retrieval when a first language of a retrieval request is different from that of a retrieval target document, comprising:
detecting retrieval words included in a plurality of documents and registering information indicating which document includes each retrieval word as a document database;
inputting a retrieval request;
translating the inputted retrieval request into a second language associated with the retrieval target document and generating a first of the retrieval words in the language of the retrieval target document;
converting a phonogram in the retrieval request which has failed to be translated by machine translation into a phonogram in the second language associated with the retrieval target document and providing it as a second of the retrieval words in the language of the retrieval target document; and
retrieving a document including the first of the retrieval words and the second of the retrieval words.
